(19) United States
(12) Patent Application Publication
(10) Pub. No.: US 2026/0149362 A1
(43) Pub. Date: May 28, 2026

(54) SEMICONDUCTOR DEVICE AND POWER SUPPLY SYSTEM

(71) Applicant: MITSUMI ELECTRIC CO., LTD., Tokyo (JP)

(72) Inventors: Yoichi TAKANO, Tokyo (JP); Kohei SAKURAI, Tokyo (JP)

(21) Appl. No.: 19/399,958

(22) Filed: Nov. 25, 2025

(30) Foreign Application Priority Data
Nov. 28, 2024 (JP) 2024-207632

(51) Int. Cl. H02M 1/32; H02M 3/155

(52) U.S. Cl. CPC H02M 1/32; H02M 3/155

(57) ABSTRACT

A rectifier circuit transmits a control signal from a control input terminal to a power supply wiring, and shuts off its reverse current path. A voltage detector circuit generates a detection voltage by performing resistance voltage division to an output voltage applied to the power supply wiring, and compares it with a judgment voltage. The voltage detector circuit controls an enable signal to be at “H” level in a case of a relation “detection voltage>judgment voltage”, or controls it to be at “L” level in a case of a relation “detection voltage<judgment voltage”. A delay device (semiconductor device) is used in a state in which one end of a capacitor is connected to a power supply terminal while a discharging resistor is connected between the power supply terminal or a control output terminal and the control input terminal.

### CROSS-REFERENCE TO RELATED APPLICATION

The present application claims priority from Japanese Patent Application No. 2024-207632 filed on Nov. 28, 2024, the content of which is hereby incorporated by reference into this application.

### TECHNICAL FIELD OF THE INVENTION

The present invention relates to a semiconductor device and a power supply system, and relates to, for example, a technique for providing a delay to a signal.

### BACKGROUND OF THE INVENTION

Japanese Patent Application Laid-open Publication No. 2007-316954 (Patent Document 1) describes a technique for reducing reverse current in a power supply device for controlling an output voltage by use of an output control transistor connected between an input terminal and an output terminal. The power supply device includes a reverse-current protection (block) circuit for blocking the reverse current of the output control transistor by controlling a backgate voltage of the output control transistor or the like. The power supply device further includes another reverse-current block circuit for blocking reverse current of a peripheral transistor of the output control transistor by controlling a backgate voltage of the peripheral transistor.

### SUMMARY OF THE INVENTION

As described in the Patent Document 1, a power supply device for supplying a power supply volage to a load device is known. The power supply device is also referred to as low dropout (LDO), high-side switch, load switch, or the like. The power supply device supplies the power supply voltage to the load device in a high potential level period of a control signal. To the contrary, the load device may perform a predetermined shut-off operation when the power supply from the power supply device is shut off. In this case, the power supply device needs to continuously supply the power to the load device when the shut-off operation is being performed, even after transition of the control signal to low potential level.

A mechanism of continuously supplying the power can be achieved by, for example, providing a delay device. A control signal for the power supply device is input to the delay device, and the delay device extends the high potential level period of the control signal by a predetermined delay time, and then, outputs the control signal to the power supply device. When a high-potential power supply voltage is supplied from the outside, the delay device can easily add the delay time to the high potential level of the control signal by use of various circuits. However, in this case, the delay device needs a terminal for supplying the high-potential power supply voltage.

Accordingly, one objective of the present invention is to provide a semiconductor device capable of extending a high potential level period of an input signal without need to supply a high-potential power supply voltage.

The above and other objectives and novel characteristics of the present invention will become apparent from the description of the present specification and the accompanying drawings.

The outline of the typical aspects of the inventions disclosed in the present application will be briefly described below.

A semiconductor device according to one embodiment includes a control input terminal, a control output terminal, a power supply wiring, a power supply terminal, a ground power supply terminal, a rectifier circuit, and a voltage detector circuit. A first control signal transiting between high potential level and low potential level is input to the control input terminal. A second control signal is output from the control output terminal. A high-potential output voltage generated from the first control signal is applied to the power supply wiring. The power supply terminal is connected to the power supply wiring. A low-potential power supply voltage is supplied to the ground power supply terminal. The rectifier circuit is connected between the control input terminal and the power supply wiring, transmits the first control signal supplied from the control input terminal, to the power supply wiring, and shuts off a current path extending from the power supply wiring to the control input terminal. The voltage detector circuit is connected to the power supply wiring, generates a detection voltage by performing resistance voltage division to the high-potential output voltage, controls the second control signal to be at high potential level when the detection voltage is higher than a judgment voltage, or controls the second control signal to be at low potential level when the detection voltage is lower than the judgment voltage. The semiconductor device is used in a state in which the power supply terminal is connected to the other end of a capacitor having one end to which a low-potential power supply voltage is supplied while a discharging resistor is connected between the power supply terminal or the control output terminal and the control input terminal.

The effects obtained by the typical aspects of the present invention disclosed in the present application will be briefly described as follows. A semiconductor device capable of extending a high potential level period of an input signal without need to supply a high-potential power supply voltage is achieved.

### BRIEF DESCRIPTIONS OF THE DRAWINGS

FIG. 1 is a schematic diagram illustrating an exemplary configuration and an exemplary operation of a power supply system according to a first embodiment;

FIG. 2 is a circuit diagram illustrating an exemplary schematic configuration of a delay device (semiconductor device) of FIG. 1;

FIG. 3 is a schematic diagram illustrating an exemplary operation of a reverse-current block circuit of FIG. 2;

FIG. 4 is a timing chart illustrating an exemplary operation of the delay device (semiconductor device) of FIG. 2;

FIG. 5 is a circuit diagram illustrating an exemplary configuration of the delay device (semiconductor device) of FIG. 2 in more detail;

FIG. 6 is a circuit diagram illustrating an exemplary schematic configuration of a modification of the delay device (semiconductor device) of FIG. 2; and

FIG. 7 is a circuit diagram illustrating an exemplary schematic configuration of a delay device (semiconductor device) according to a second embodiment.

### DESCRIPTIONS OF THE PREFERRED EMBODIMENTS

Although not particularly limited, a circuit element configuring each functional block in the following embodiments is formed on a semiconductor substrate made of single crystal silicon or the like by an integrated circuit technique such as publicly-known complementary metal oxide semiconductor (CMOS). In the following embodiments, a p-channel metal oxide semiconductor field effect transistor (MOSFET) and an n-channel MOSFET are referred to as pMOS transistor and nMOS transistor, respectively.

Hereinafter, embodiments of the present invention will be described in detail with reference to the accompanying drawings. Note that the same components are denoted with the same reference symbols throughout all the drawings for describing the embodiments, and the repetitive description thereof will be omitted.

### First Embodiment

### <Outline of Power Supply System>

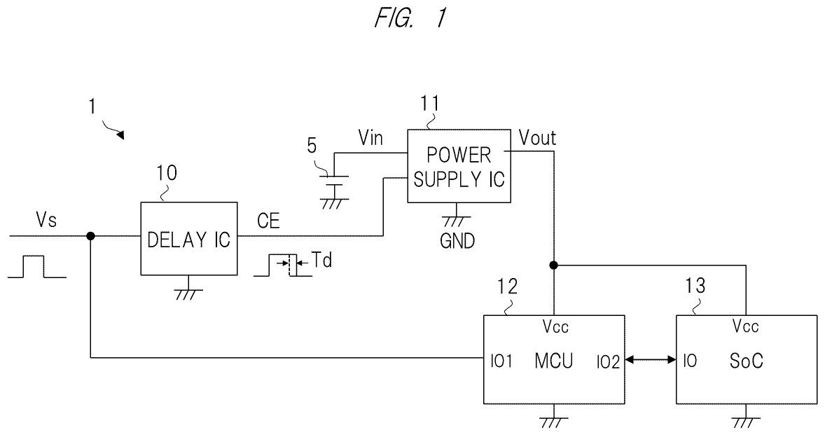

FIG. 1 is a schematic diagram illustrating an exemplary configuration and an exemplary operation of a power supply system according to a first embodiment. A power supply system 1 illustrated in FIG. 1 includes, for example, a delay device (semiconductor device) 10, a power supply device 11, and two load devices 12 and 13 mounted on a wiring board. The wiring board is, for example, a wiring board for liquid crystal display (LCD) processings. The load device 13 is, for example, a system on chip (SoC) in charge of various LCD display processings such as luminance adjustment and contrast adjustment. The load device 12 is a micro controller unit (MCU).

A high-potential power supply voltage Vcc and a low-potential power supply voltage that is a ground power supply voltage GND are supplied to the two load devices 12 and 13. The load device 12 includes two IO ports “IO1” and “IO2”. The load device 13 includes one IO port “IO”. The load device 12 communicates with the IO port IO of the load device 13 via the IO port IO2 of its own. In the load device 12, a control signal (first control signal) Vs from an external device (not illustrated) such as a main substrate is input to the IO port IO1. The control signal Vs transits between a high potential level and a low potential level, in other words, between an “H” level and an “L” level.

An external power supply voltage Vin from an external power supply device 5, the ground power supply voltage GND, and an enable signal (second control signal) CE are input to the power supply device 11. The enable signal CE also transits between “H” level and “L” level. The power supply device 11 supplies the power supply voltage Vcc to the two load devices 12 and 13 during the “H” level period of the enable signal CE. That is, the power supply device 11 supplies an output power supply voltage Vout having been output to the two load devices 12 and 13 during the “H” level period of the enable signal CE.

The power supply device 11 includes an input terminal to which the external power supply voltage Vin is input, an output terminal from which the output power supply voltage Vout is output, and a load switch for connecting the input terminal and the output terminal. The load switch is controlled to be in the ON state during the “H” level period of the enable signal CE, and connects the input terminal to the output terminal. The power supply device 11 may include a regulator circuit for generating the output power supply voltage Vout of 3.3 V when the external power supply voltage Vin is about 12 V.

In the configuration, for example, when LCD display is changed from the ON state to the OFF state, in other words, when the two load devices 12 and 13 are instructed to switch off the LCD display, the external device not illustrated performs transition of the control signal Vs from “H” level to “L” level. At this time, it is desirable to also shut off the power supply to the two load devices 12 and 13 in order to reduce the power consumption.

When the shut off of the power supply to the load devices 12 and 13 is simply necessary, it is sufficient that the external device outputs the control signal Vs as the enable signal CE to the power supply device 11. In this case, it is sufficient that the power supply device 11 stops supplying the power supply voltage Vcc to the two load devices 12 and 13 in response to the transition of the control signal Vs, resultantly the enable signal CE, to “L” level.

To the contrary, when the power supply is shut off depending on the states of the load devices 12 and 13, for example, various items of setting data, status data, and the like are to be saved from the load device 13 to the load device 12. In the example of FIG. 1, the load device 12 communicates with the load device 13 in response to the transition of the control signal Vs to “L” level, thereby saving setting data, status data, and the like for display processings into a nonvolatile memory of its own. However, in a case of such an operation, it is necessary to continuously supply the power supply voltage Vcc to the load devices 12 and 13 during the saving operation.

Therefore, the delay device (semiconductor device) 10 is provided. The control signal (first control signal) Vs supplied from the outside is input to the delay device 10. Then, the delay device 10 generates a signal which is obtained by extending the “H” level period of the control signal Vs, and outputs the signal as the enable signal CE to the power supply device 11. In the example of FIG. 1, the “H” level period of the enable signal CE is, for example, off-delay time Td of, for example, about several hundred ms, longer than the “H” level period of the control signal Vs. Thereby, after the transition of the control signal Vs to “L” level, the power supply voltage Vcc can be continuously supplied to the load devices 12 and 13 during the off-delay time Td.

Note that the power supply system 1 described here is the system for LCD display processings. However, the present invention is not limited to this, and the system may be for other use. That is, some general load devices may perform any shut-off operation when the power supply from the power supply device 11 is shut off. Also in this case, even in the transition of the control signal Vs to “L” level, the power supply device 11 is to continuously supply the power to the load devices during the shut-off operation.

In the power supply system 1 as described above, if the high-potential power supply voltage is supplied, the delay device can easily add the off-delay time Td to the control signal Vs by use of various digital circuits or analog circuits. In this case, the delay device includes, for example, a total of five terminals that are two terminals to which the high-potential and the low-potential power supply voltages are supplied, respectively, the terminal to which the control signal Vs is input, the terminal from which the enable signal CE is output, and the terminal for delay. A capacitor, a resistor, and the like for generating the delay time of, for example, several hundred ms, are connected to the terminal for delay.

However, in this case, the delay device needs to include a terminal to which the high-potential power supply voltage is supplied. This may result in, for example, an increase in size of the delay device, resultantly an increase in cost. Further, since the high-potential power supply voltage is supplied, power consumption of the delay device may increase. To the contrary, it is conceivable that the power supply device 11 to which the high-potential power supply voltage is already supplied includes the functions of the delay device.

However, this case needs to use a special power supply device 11 not used for general purpose, and therefore, there may be a risk of the increase in cost. The increase in size of the power supply device 11 may also increase the cost. Particularly, if the external power supply voltage Vin is about 12 V, the functions of the delay device may be made of a large-scaled high-voltage transistor having a high breakdown voltage. Thus, because of this, as illustrated in FIG. 1, the delay device 10 not including the terminal to which the high-potential power supply voltage is supplied is to be provided separately from the power supply device 11.

### <Outline of Delay Device (Semiconductor Device)>

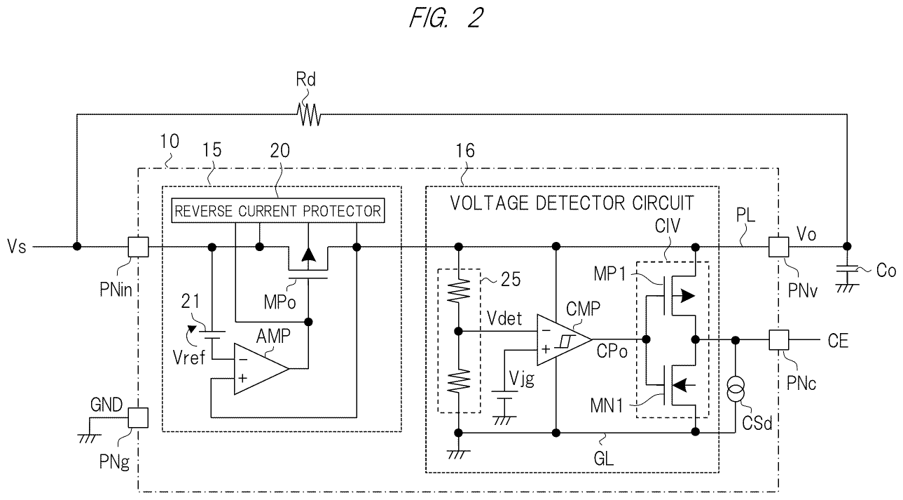

FIG. 2 is a circuit diagram illustrating an exemplary schematic configuration of the delay device (semiconductor device) 10 of FIG. 1. The delay device (semiconductor device) 10 illustrated in FIG. 2 is made of, for example, a package including one semiconductor chip. The delay device 10 includes a total of four terminals that are a control input terminal PNin, a control output terminal PNc, a power supply terminal PNv, and a ground power supply terminal PNg. The delay device 10 includes a rectifier circuit 15, a voltage detector circuit 16, a current source CSd for discharging, and a power supply wiring PL, formed on the semiconductor chip.

The control signal (first control signal) Vs from the external device is input to the control input terminal PNin. The control output terminal PNc outputs the enable signal (second control signal) CE to the power supply device 11. The power supply terminal PNv is connected to the power supply wiring PL. A high-potential output voltage Vo generated from the control signal Vs is applied to the power supply wiring PL as described later. The low-potential power supply voltage that is the ground power supply voltage GND is supplied to the ground power supply terminal PNg.

The rectifier circuit 15 is connected between the control input terminal PNin and the power supply wiring PL. The rectifier circuit 15 transmits the control signal Vs from the control input terminal PNin to the power supply wiring PL, and shuts off a current path extending from the power supply wiring PL to the control input terminal PNin. That is, the rectifier circuit 15 functions as a diode with the control input terminal PNin as anode and the power supply wiring PL as cathode, that functions as an ideal diode in this example.

Specifically, the rectifier circuit 15 includes a pMOS transistor MPo, an amplifier circuit AMP, a voltage source 21, and a reverse-current block circuit 20. The pMOS transistor MPo forms a source-drain path between the control input terminal PNin and the power supply wiring PL. The voltage source 21 generates a setting voltage that is a reference voltage Vref of, for example, 50 mV lower than the voltage of the control input terminal PNin. The amplifier circuit AMP controls a gate voltage of the pMOS transistor MPo in negative feedback such that the setting voltage is equal to the output voltage Vo applied to the power supply wiring PL.

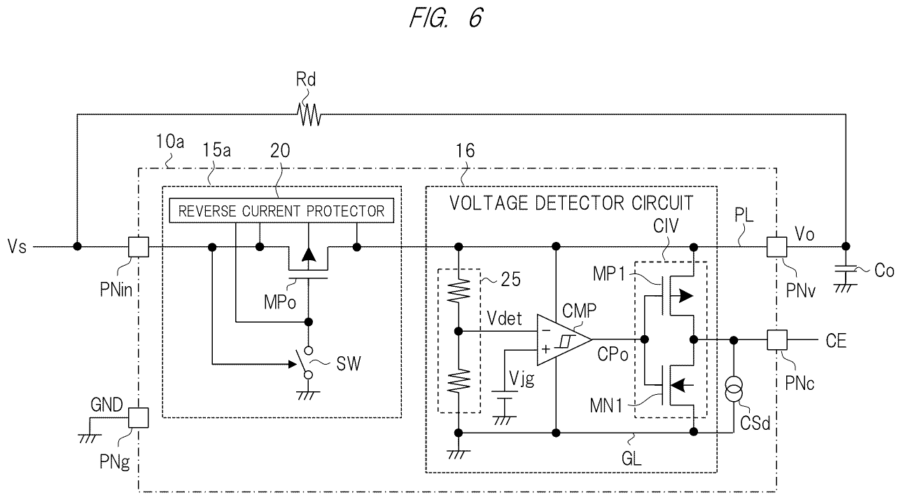

Since the amplifier circuit AMP and the voltage source 21 are provided, a differential voltage between the voltage level of the control signal Vs and the voltage level of the output voltage Vo is kept at a constant value based on the reference voltage Vref. Thereby, in assumption that the “H” level voltage value of the control signal Vs is expressed as “VDD,” the output voltage Vo is a fixed voltage of “VDD−Vref.” Although the output voltage Vo is not the fixed voltage, the rectifier circuit 15 may be a high-side switch or load switch not including the amplifier circuit AMP and the voltage source 21 as described later in FIG. 6.

The reverse-current block circuit 20 compares the voltage of the control input terminal PNin with the output voltage Vo applied to the power supply wiring PL. The reverse-current block circuit 20 controls the backgate voltage or gate voltage of the pMOS transistor MPo, based on the comparison result. Thereby, the reverse-current block circuit 20 blocks the reverse current flowing from the power supply wiring PL to the control input terminal PNin. Note that the configuration similar to that of the rectifier circuit 15 is also applicable to the load switch included in the power supply device 11 illustrated in FIG. 1.

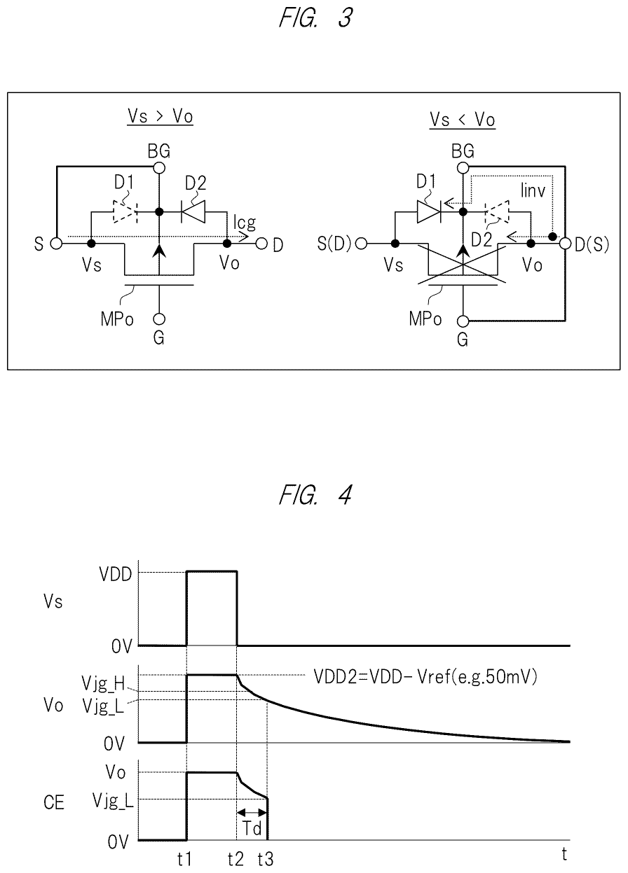

FIG. 3 is a schematic diagram illustrating an exemplary operation of the reverse-current block circuit 20 of FIG. 2. As illustrated in FIG. 3, more specifically, the pMOS transistor MPo switches body diodes D1 and D2 as parasitic elements by backgate (BG) switching. A backgate (BG) side of the body diode D1 is formed as cathode between a source(S) and the backgate (BG) in the pMOS transistor MPo. A backgate (BG) side of the body diode D2 is formed as cathode between a drain (D) and the backgate (BG) in the pMOS transistor MPo.

If the voltage level of the control signal Vs is higher than the voltage level of the output voltage Vo, the reverse-current block circuit 20 connects the backgate (BG) of the pMOS transistor MPo to the source(S). Thereby, the body diode D1 is disabled. Then, the pMOS transistor MPo in the ON state makes a flow of a current, that is a charging current Icg in this case, from the source(S) to the drain (D) via a channel. Note that a relation “Vs>Vo” is established in this case, and thus, a reverse current Iinv does not flow from the drain (D) to the source(S).

To the contrary, if the voltage level of the control signal Vs is lower than the voltage level of the output voltage Vo, the reverse-current block circuit 20 connects the backgate (BG) of the pMOS transistor MPo to the drain (D). Thereby, the body diode D2 is disabled. Further, the reverse-current block circuit 20 connects the gate (G) of the pMOS transistor MPo to the drain (D). However, a relation “Vs<Vo” is established in this case, and thus, the drain (D) actually functions as the source(S). Thereby, the pMOS transistor MPo is fixed in the OFF state.

In the case of “Vs<Vo,” the reverse current Iinv can flow from the drain (D) to the source(S). Note that the pMOS transistor MPo is in the OFF state while the body diode D1 is in the enabled state. Thus, the reverse current Iinv is shut off. Since the reverse-current block circuit 20 is provided as described above, the pMOS transistor MPo functions as an ideal diode. That is, the pMOS transistor MPo makes the flow of the charging current Icg from the source(S) to the drain (D) via the channel with low ON resistance, and shuts off the reverse current Iinv from the drain (D) to the source(S).

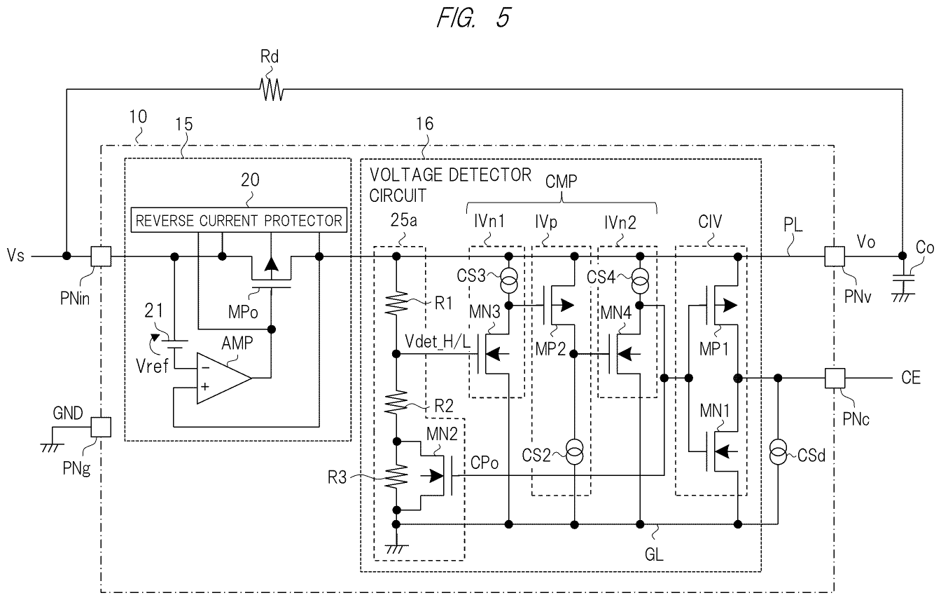

For example, use of a general diode instead of the ideal diode may cause forward voltage drop of 0.7 V. In this case, the voltage value VDD2 illustrated in FIG. 4 is, for example, 2.6 V. In order to achieve the same off-delay time Td as that in the case of the voltage value VDD2 of “VDD-Vref” such as 3.25 V, it is necessary to set the time constant “Co×Rd” to be an excessively large value. The larger the time constant “Co×Rd” is, the larger the sizes of the components may be, and besides, the lower the accuracy in setting the off-delay time Td may be along with the gentler gradient. Thus, it is beneficial to use the ideal diode which does not cause the forward voltage drop.

Return to FIG. 2. The voltage detector circuit 16 is connected to the power supply wiring PL and a ground power supply wiring GL, and is operated by the output voltage Vo applied to the power supply wiring PL and the ground power supply voltage GND supplied to the ground power supply wiring GL. Schematically, the voltage detector circuit 16 first performs resistance voltage division to the output voltage Vo, thereby generating a detection voltage Vdet. If the detection voltage Vdet is higher than the judgment voltage Vjg, the voltage detector circuit 16 controls the enable signal CE to be at “H” level. To the contrary, if the detection voltage Vdet is lower than the judgment voltage Vjg, the voltage detector circuit 16 controls the enable signal CE to be at “L” level.

Specifically, the voltage detector circuit 16 includes a resistance voltage divider circuit 25, a comparator circuit CMP, and a CMOS inverter circuit CIV. The resistance voltage divider circuit 25 performs the resistance voltage division to the output voltage Vo by using series-connected resistors, thereby generating the detection voltage Vdet. The comparator circuit CMP is operated by the output voltage Vo and the ground power supply voltage GND, and compares the detection voltage Vdet with the judgment voltage Vjg. Note that the voltage detector circuit 16 is configured to have low current consumption in order to suppress the influence on the time constant “Co×Rd” based on a discharging resistor Rd.

If a relation “Vdet>Vjg” is established, the comparator circuit CMP outputs the “L” level as a comparison output signal CPo indicating a comparison result. To the contrary, if a relation “Vdet<Vjg” is established, the comparator circuit CMP outputs “H” level as the comparison output signal CPo. Note that the comparator circuit CMP is more preferably made of, for example, a hysteresis comparator circuit for preventing chattering.

The CMOS inverter circuit CIV includes a pMOS transistor MP1 with its source connected to the power supply wiring PL, and an nMOS transistor MN1 with its source connected to the ground power supply wiring GL. The CMOS inverter circuit CIV controls the enable signal CE to be at “H” level as the level of the output voltage Vo or “L” level as the level of the ground power supply voltage GND, based on the comparison result of the comparator circuit CMP. That is, the CMOS inverter circuit CIV inverts the comparison output signal CPo of “L” level, thereby outputting the enable signal CE of “H” level, and inverts the comparison output signal CPo of “H” level, thereby outputting the enable signal CE of “L” level.

In the configuration, the delay device (semiconductor device) 10 is used while one end of a capacitor Co is connected to the power supply terminal PNv. The ground power supply voltage GND is supplied to the other end of the capacitor Co. Additionally, the delay device 10 is used while the discharging resistor Rd is connected between the power supply terminal PNv and the control input terminal PNin.

Thereby, the capacitor Co is charged via the rectifier circuit 15 and the power supply wiring PL in the “H” level period of the control signal Vs. The voltage detector circuit 16 is operated by the voltage of the power supply wiring PL via the rectifier circuit 15 and the output voltage Vo maintained in the capacitor Co. Since the relation “Vdet>Vjg” is established in the “H” level period of the control signal Vs, the voltage detector circuit 16 outputs the “H” level as the enable signal CE.

To the contrary, by the transition of the control signal Vs from “H” level to “L” level, the output voltage Vo maintained in the capacitor Co is discharged via the discharging resistor Rd, and thus, drops based on the predetermined time constant “Co×Rd”. At this time, the voltage detector circuit 16 can continuously operate unless the output voltage Vo becomes lower than its operation lower limit voltage. If the relation “Vdet<Vjg” is established during the continuous operation period by the drop of the output voltage Vo, the voltage detector circuit 16 switches the enable signal CE to “L” level.

Then, when the output voltage Vo becomes lower than the operation lower limit voltage of the voltage detector circuit 16, specifically the comparator circuit CMP and the nMOS transistor MN1, the control output terminal PNc becomes in a high impedance state. This case may cause malfunction of a power supply device 11 at a downstream stage illustrated in FIG. 1. Thus, a discharging current source CSd is provided in FIG. 2. The discharging current source CSd is a pull-down element for applying the ground power supply voltage GND to the control output terminal PNc when the control output terminal PNc is in the high impedance state. The current source CSd may be made of, for example, a depression-type nMOS transistor in which gate-source is short-circuited. The pull-down element is not limited to the current source, and may be, for example, a high-resistance resistor.

FIG. 4 is a timing chart illustrating an exemplary operation of the delay device (semiconductor device) 10 of FIG. 2. In FIG. 4, the control signal Vs is input to the control input terminal PNin of the delay device 10. In this example, the control signal Vs is controlled to be at “H” level in the period from time t1 to time t2. The “H” level at this time indicates the level of the voltage value VDD such as 3.3 V.

In the period from time t1 to time t2, the rectifier circuit 15 transmits the control signal Vs with the level of the voltage value VDD as the output voltage Vo to the power supply wiring PL connected with the capacitor Co. At this time, as described above, the voltage value VDD2 of the output voltage Vo is at a fixed voltage that is the reference voltage Vref of 50 mV lower than the voltage value VDD of 3.3 V. Since the detection voltage Vdet resultantly the output voltage Vo is higher than the judgment voltage Vjg_H for “H” level judgment, the voltage detector circuit 16 outputs the “H” level having the level of the output voltage Vo as the enable signal CE.

Then, when the control signal Vs transits to “L” level of 0 V at time t2, the charge on the capacitor Co finishes. Thereby, the output voltage Vo drops based on the predetermined time constant “Co×Rd”. Then, at time t3, the detection voltage Vdet resultantly the output voltage Vo reaches the judgment voltage Vjg_L for “L” level judgment. Accordingly, the voltage detector circuit 16 switches the enable signal CE to “L” level of 0 V. Note that the judgment voltage Vjg_L is defined based on a property of a signal input circuit provided at a downstream stage. That is, the judgment voltage Vjg_L is set to a value such as about 2.0 V that is higher than an upper limit of a threshold of the signal input circuit.

The period from time t2 to time t3 corresponds to the off-delay time Td illustrated in FIG. 1. A length of the off-delay time Td can be optionally set from the judgment voltage Vjg_L and the time constant “Co×Rd”. The time constant can be more flexibly and accurately set when the capacitor Co and the discharging resistor Rd are provided as external components of the delay device 10, than when they are provided inside the delay device 10. Further, the time constant can be accurately set irrespective of temperature. However, for example, the discharging resistor Rd may be provided in the delay device 10 in order to, for example, reduce the cost of the external components.

In this case, as a comparative example, it is also conceivable that the output voltage Vo is used as the enable signal CE without the provision of the voltage detector circuit 16. Even in this case, the length of the off-delay time Td can be set from the time constant “Co×Rd”. However, this case may change the length of the off-delay time Td depending on the threshold of the signal input circuit at the downstream stage, such as the input circuit for the enable signal CE in the power supply 11. At this time, the threshold of the signal input circuit at the downstream stage may vary depending on a variation in process or a variation in temperature. Consequently, it may be difficult to accurately define the length of the off-delay time Td.

Particularly, if the off-delay time Td needs to have a certain length such as several hundred ms, it is necessary to define the time constant “Co×Rd” to be a relatively large value. Thus, the variation range of the off-delay time Td depending on the threshold may be larger. Consequently, it may be more difficult to accurately define the length of the off-delay time Td.

To the contrary, by the provision of the voltage detector circuit 16, the enable signal CE can be actively dropped to “L” level at a certain point. Thus, the length of the off-delay time Td can be accurately set without the influence of the threshold of the signal input circuit at the downstream stage. The length of the off-delay time Td can be relatively flexibly set by use of two parameters.

As a specific example, the length of the off-delay time Td can be defined from the judgment voltage Vjg_L while the capacitance of the capacitor Co resultantly the time constant “Co×Rd” is set to be a relatively large value. In this case, the length of the off-delay time Td can be accurately defined while the operation continuous period after time t2 by the voltage detector circuit 16 or the like can be sufficiently secured. Note that the capacitance of the capacitor Co may be, for example, about 10 uF.

### <Details of Delay Device (Semiconductor Device)>

FIG. 5 is a circuit diagram illustrating an exemplary more-detailed configuration of the delay device (semiconductor device) 10 of FIG. 2. FIG. 5 illustrates an exemplary more-detailed configuration of the voltage detector circuit 16 of FIG. 2. The voltage detector circuit 16 illustrated in FIG. 5 includes a resistance voltage divider circuit 25a, three-level inverter circuits IVn1, IVp, and IVn2, and the CMOS inverter circuit CIV at the downstream stage. The three-level inverter circuits IVn1, IVp, and IVn2 among these components configure the comparator circuit CMP illustrated in FIG. 2.

The resistance voltage divider circuit 25a includes an nMOS transistor MN2 in addition to three resistors R1, R2, and R3. The three resistors R1, R2, and R3 are connected in series between the power supply wiring PL to which the output voltage Vo is applied and the ground power supply wiring GL to which the ground power supply voltage GND is supplied. The nMOS transistor MN2 is connected in parallel to the resistor R3. The nMOS transistor MN2 is switched on/off in response to the comparison output signal CPo from the comparator circuit CMP. In this way, the resistance voltage divider circuit 25a is configured to change the resistance voltage division ratio in response to the comparison result of the comparator circuit CMP.

Specifically, when the comparison output signal CPo is at “H” level, in other words, when the detection voltage Vdet is lower than the judgment voltage such that the enable signal CE is at “L” level, the resistance voltage divider circuit 25a performs resistance voltage division to the output voltage Vo into the two resistors R1 and R2. Thereby, the resistance voltage divider circuit 25a generates a detection voltage Vdet_H for “H” level judgment. To the contrary, when the comparison output signal CPo is at “L” level, in other words, when the detection voltage Vdet is higher than the judgment voltage such that the enable signal CE is at “H” level, the resistance voltage divider circuit 25a performs resistance voltage division to the output voltage Vo into the one resistors R1 and the two resistors R2 and R3. Thereby, the resistance voltage divider circuit 25a generates a detection voltage Vdet_L for “L” level judgment.

The detection voltage Vdet_H for “H” level judgment is expressed as “R2/(R1+R2)”. To the contrary, the detection voltage Vdet_L for “L” level judgment is expressed as “(R2+R3)/(R1+R2+R3)” higher than the detection voltage Vdet_H for “H” level judgment. In the examples of FIGS. 2 and 4, the judgment voltage Vjg is changed depending on the comparison result, thereby achieving the hysteresis comparator circuit. To the contrary, in the example of FIG. 5, the detection voltage Vdet is changed depending on the comparison result, thereby achieving the hysteresis comparator circuit. At least any of the three resistors R1, R2, and R3 may be a trimming-enabled variable resistor in order to enhance accuracy of the resistance voltage division ratio resultantly accuracy in detecting the output voltage Vo.

The inverter circuit IVn1 includes an nMOS transistor MN3 and a load current source CS3. The ground power supply voltage GND is supplied to a source of the nMOS transistor MN3, and the detection voltage Vdet that is the detection voltage Vdet_H for “H” level judgment or the detection voltage Vdet_L for “L” level judgment from the resistance voltage divider circuit 25a is input to a gate thereof. The load current source CS3 is connected between a drain of the nMOS transistor MN3 and the power supply wiring PL.

The inverter circuit IVp includes a pMOS transistor MP2 and a load current source CS2. The output voltage Vo is applied to a source of the pMOS transistor MP2, and a signal from the inverter circuit IVn1 at the upstream stage is input to a gate thereof. The load current source CS2 is connected between a drain of the pMOS transistor MP2 and the ground power supply wiring GL. The inverter circuit IVn2 includes an nMOS transistor MN4 and a load current source CS4. The ground power supply voltage GND is supplied to a source of the nMOS transistor MN4, and a signal from the inverter circuit IVp at the upstream stage is input to a gate thereof. The load current source CS4 is connected between a drain of the nMOS transistor MN4 and the power supply wiring PL.

Each of the three inverter circuits IVn1, IVp, and IVn2 inverts a signal from its upstream, and outputs the inverted signal to its downstream. Each of the three load current sources CS2 to CS4 may be made of, for example, a depression-type MOS transistor in which gate-source is short-circuited. A high-resistance resistor may be provided instead of the load current source. The CMOS inverter circuit CIV includes the pMOS transistor MP1 and the nMOS transistor MN1 as similar to FIG. 2. The CMOS inverter circuit CIV inverts a signal from the inverter circuit IVn2 that is the comparison output signal CPo, thereby outputting the enable signal CE.

In the configuration, the judgment voltage Vjg is defined based on the threshold voltage (Vth) between the gate and the source of the nMOS transistor MN3 by the inverter circuit IVn1 provided at the initial stage in the comparator circuit CMP. For example, in the period before time t1 in FIG. 4, the resistance voltage divider circuit 25a outputs the detection voltage Vdet_H (<Vdet_L) for “H” level judgment in response to the comparison output signal CPo of “H” level. At time t1, the nMOS transistor MN3 is turned on when the detection voltage Vdet_H becomes higher than the certain threshold voltage (Vth). Consequently, the inverter circuit IVn1 outputs “L” level, thereby causing the transition of the enable signal CE to “H” level.

Then, in the period from time t1 to time t3, the resistance voltage divider circuit 25a outputs the detection voltage Vdet_L (>Vdet_H) for “L” level judgment in response to the comparison output signal CPo of “L” level. At time t3, the nMOS transistor MN3 is turned off when the detection voltage Vdet_L becomes lower than the certain threshold voltage (Vth). Consequently, the inverter circuit IVn1 outputs “H” level, thereby causing the transition of the enable signal CE to “L” level. Note that the relation “Vdet_H<Vdet_L” between the two detection voltages Vdet_H and Vdet_L is equivalent to the relation “Vjg_H>Vjg_L” between the two judgment voltages Vjg_H and Vjg_L illustrated in FIG. 4.

By use of the above circuit configuration, the voltage detector circuit 16 with hysteresis property can be achieved without providing a voltage source for judgment voltage. Thereby, the circuit scale of the voltage detector circuit 16 can be decreased. For an effect of the decrease in the circuit scale, it is necessary to continuously operate the voltage detector circuit 16 and the like at the output voltage Vo of the capacitor Co in the period after time t2 in FIG. 4. Strictly speaking, the current consumption of the voltage detector circuit 16 affects the gradient of the output voltage Vo on discharging in FIG. 4.

Therefore, the reduction in the power consumption by the suppression of the circuit scale of the voltage detector circuit 16 is beneficial. In order to reduce the power consumption, it is desirable to set the current values of the load current sources CS2 to CS4 to be as low as possible. Also, it is desirable to set the resistance values of the three resistors R1 to R3 in the resistance voltage divider circuit 25a to be as high as possible.

### <Modification Example of Rectifier Circuit>

The rectifier circuit 15 illustrated in FIG. 2 described here only needs to be a circuit playing a role of a diode function, more preferably a circuit playing a role of the function of the ideal diode. Thus, the delay device may include, for example, a rectifier circuit 15a as illustrated in FIG. 6. The delay device may further include, for example, a diode with low forward voltage such as a Schottky barrier diode.

FIG. 6 is a circuit diagram illustrating an exemplary schematic configuration of a modification of the delay device (semiconductor device) illustrated in FIG. 2. A delay device (semiconductor device) 10a of FIG. 6 is different from that of FIG. 2 in the configuration of the rectifier circuit 15a. The rectifier circuit 15a illustrated in FIG. 6 includes a switch SW instead of the amplifier circuit AMP and the voltage source 21 illustrated in FIG. 2. The switch SW is controlled to be turned on/off in response to the control signal Vs. When being controlled to be turned on in response to the control signal Vs of “H” level, the switch SW applies the ground power supply voltage GND to the gate of the pMOS transistor MPo. Consequently, the pMOS transistor MPo is controlled to be in the ON state. In this way, the pMOS transistor MPo functions as a high-side switch or load switch.

As similar to FIG. 2, the rectifier circuit 15a also functions as the ideal diode. By use of the rectifier circuit 15a, the voltage value VDD2 of the output voltage Vo in the period from time t1 to time t2 in FIG. 4 is equal to the voltage value VDD of the control signal Vs. If the charging current Icg flowing in the pMOS transistor MPo is not so large, the variation in the output voltage Vo can be suppressed without increasing the size of the pMOS transistor MPo. Thus, the rectifier circuit 15 of FIG. 2 may be replaced with the rectifier circuit 15a of FIG. 6.

<principal Effects of First Embodiment>

By the use of the system according to the first embodiment, the high potential level period of the input signal that is the control signal Vs in the case can be extended to be longer by the off-delay time Td, without the supply of the high-potential power supply voltage. Consequently, the delay device (semiconductor device) does not need the terminal to which the high-potential power supply voltage is supplied, thereby downsizing the delay device and reducing its cost. Further, the power consumption of the delay device can be reduced. Since the voltage detector circuit is provided, the signal of the high potential level can be actively dropped to the low potential level after the off-delay time Td. This results in removal of the variation factor of the off-delay time Td, caused by the variation in the threshold of the signal input circuit at the downstream stage.
(1) Since the capacitor Co and the discharging resistor Rd used for defining the time constant “Co×Rd” are provided as external components that are discrete components, the accurate time constant with the small temperature dependence can be set. Additionally, the long time constant can be easily set. (2) Since the rectifier circuit 15 that is the ideal diode as illustrated in FIG. 2 is provided, the output voltage Vo can be defined as the fixed voltage “VDD - Vref” with small voltage drop and small temperature dependence. (3) Since the voltage detector circuit 16 is provided as illustrated in FIG. 5, the accuracy in detecting the output voltage Vo can be increased. Further, since the voltage detector circuit 16 is configured to operate at low power consumption, the influence on the time constant can be decreased. A combination of (1) to (3) can increase the accuracy in setting the off-delay time Td irrespective of temperature.

### Second Embodiment

### <Outline of Delay Device (Semiconductor Device)>

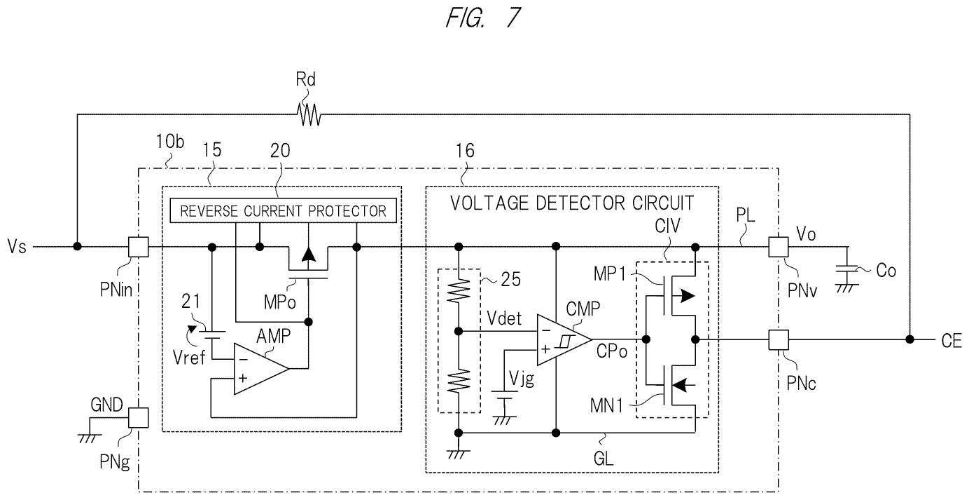

FIG. 7 is a circuit diagram illustrating an exemplary schematic configuration of a delay device (semiconductor device) 10b according to a second embodiment. The exemplary configuration of the delay device (semiconductor device) 10b of FIG. 7 is different from that of FIG. 2 in the following two points. The first difference is that the discharging resistor Rd is connected between not the power supply terminal PNv but the control input terminal PNin and the control output terminal PNc. The second difference is that the discharging current source CSd illustrated in FIG. 2 is not provided.

In the configuration, for example, in the period from time t2 to time t3 in FIG. 4, the capacitor Co can be discharged in a current path through the power supply wiring PL, the turned-on pMOS transistor MP1, and the discharging resistor Rd. At this time, the on resistance of the pMOS transistor MP1 is generally sufficiently low, and thus, the time constant for discharging can be defined as “Co×Rd” as similar to FIG. 2.

At time t3, the enable signal CE is controlled to be at “L” level through the turned-on nMOS transistor MN1. Then, even when the nMOS transistor MN1 is turned off by the drop of the output voltage Vo, the enable signal CE is maintained at “L” level in a path through the discharging resistor Rd. Thus, the discharging current source CSd illustrated in FIG. 2 is unnecessary.

### <Principal Effects of Second Embodiment>

The use of the system according to the second embodiment as described above provides effects similar to the various effects of the first embodiment. Further, since the discharging current source CSd is unnecessary, the circuit scale of the delay device (semiconductor device) can be more reduced.

In the foregoing, the invention made by the inventors of the present application has been concretely described based on the embodiments. However, the present invention is not limited to the foregoing embodiments, and various modifications can be made within the scope of the present invention. For example, the above-described embodiments have been explained in detail for making the present invention understandable, and are not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

What is claimed is:

1. A semiconductor device comprising:
a control input terminal to which a first control signal transiting between high potential level and low potential level is input;
a control output terminal from which a second control signal is output;
a power supply wiring to which a high-potential output voltage generated from the first control signal is applied;
a power supply terminal connected to the power supply wiring;
a ground power supply terminal to which a low-potential power supply voltage is supplied;
a rectifier circuit connected between the control input terminal and the power supply wiring, transmitting the first control signal supplied from the control input terminal to the power supply wiring, and shutting off a current path extending from the power supply wiring to the control input terminal; and
a voltage detector circuit connected to the power supply wiring, generating a detection voltage by performing resistance voltage division to the high-potential output voltage, controlling the second control signal to be at the high potential level when the detection voltage is higher than a judgment voltage, or controlling the second control signal to be at the low potential level when the detection voltage is lower than the judgment voltage,
wherein the semiconductor device is used in a state in which the power supply terminal is connected to the other end of a capacitor having one end to which the low-potential power supply voltage is supplied while a discharging resistor is connected between the power supply terminal or the control output terminal and the control input terminal.

2. The semiconductor device according to claim 1,
wherein the voltage detector circuit includes:
a resistance voltage divider circuit generating the detection voltage by performing resistance voltage division to the high-potential output voltage;
a comparator circuit operating at the high-potential output voltage and comparing the detection voltage with the judgment voltage; and
a CMOS inverter circuit controlling the second control signal to be at a level of the high-potential output voltage or a level of the low-potential power supply voltage, based on a comparison result of the comparator circuit.

3. The semiconductor device according to claim 2,
wherein the comparator circuit includes a MOSFET having a gate to which the detection voltage is input, and
the judgment voltage is defined based on a threshold voltage between the gate and a source of the MOSFET.

4. The semiconductor device according to claim 3,
wherein the resistance voltage divider circuit is configured to change a resistance voltage division ratio in response to the comparison result of the comparator circuit.

5. The semiconductor device according to claim 1,
wherein the rectifier circuit includes:
a p-channel MOSFET in which a source-drain path is formed between the control input terminal and the power supply wiring; and
a reverse-current block circuit blocking a reverse current flowing from the power supply wiring to the control input terminal by comparing a volage of the control input terminal with the high-potential output voltage applied to the power supply wiring and controlling a backgate voltage or a gate voltage of the p-channel MOSFET, based on a comparison result.

6. The semiconductor device according to claim 1, further comprising:
a pull-down element used for applying the low-potential power supply voltage to the control output terminal when the control output terminal is in a high impedance state,
wherein the discharging resistor is connected between the power supply terminal and the control input terminal.

7. A power supply system comprising:
a delay device to which a first control signal transiting between a high potential level and a low potential level is input and from which a second control signal obtained by extending a period of the high potential level of the first control signal is output;
a predetermined load device;
a power supply device to which an external power supply voltage is input, and which supplies a power supply voltage to the load device in a period of the high potential level of the second control signal; and
a capacitor and a discharging resistor,
wherein the delay device includes:
a control input terminal to which the first control signal is input;
a control output terminal from which the second control signal is output;
a power supply wiring to which a high-potential output voltage generated from the first control signal is applied;
a power supply terminal connected to the power supply wiring;
a ground power supply terminal to which a low-potential power supply voltage is supplied;
a rectifier circuit connected between the control input terminal and the power supply wiring, transmitting the first control signal supplied from the control input terminal to the power supply wiring, and shutting off a current path extending from the power supply wiring to the control input terminal; and
a voltage detector circuit connected to the power supply wiring, generating a detection voltage by performing resistance voltage division to the high-potential output voltage, controlling the second control signal to be at the high potential level when the detection voltage is higher than a judgment voltage, or controlling the second control signal to be at the low potential level when the detection voltage is lower than the judgment voltage,
the low-potential power supply voltage is supplied to one end of the capacitor, and the other end of the capacitor is connected to the power supply terminal, and
the discharging resistor is connected between the power supply terminal or the control output terminal and the control input terminal.

8. The power supply system according to claim 7,
wherein the voltage detector circuit includes:
a resistance voltage divider circuit generating the detection voltage by performing resistance voltage division to the high-potential output voltage;
a comparator circuit operating at the high-potential output voltage and comparing the detection voltage with the judgment voltage; and
a CMOS inverter circuit controlling the second control signal to be at a level of the high-potential output voltage or a level of the low-potential power supply voltage, based on a comparison result of the comparator circuit.

9. The power supply system according to claim 7,
wherein the first control signal is input to the load device, and
the load device performs a predetermined operation in response to a transition of the first control signal to the low potential level.
